(19) United States
(12) Patent Application Publication
(10) Pub. No.: US 2026/0067641 A1
(43) Pub. Date: Mar. 5, 2026

(54) LOCATION TRACKING AND DISTRESS NOTIFICATIONS USING WIRELESS NETWORK

(71) Applicant: T-MOBILE INNOVATIONS LLC, Overland Park, KS (US)

(72) Inventors: Maikel E. FALTAOUS, Renton, WA (US); Kristopher Michael MCNEIL, Sammamish, WA (US)

(21) Appl. No.: 18/824,813

(22) Filed: Sep. 4, 2024

(51) Int. Cl. H04W 4/029; H04W 52/02

(52) U.S. Cl. CPC H04W 4/029; H04W 52/0277

(57) ABSTRACT

This patent application introduces an advanced modification to tracking mechanisms for User Equipment (UE). By modifying a UE's functionality when its battery charge level is below a predetermined threshold, the UE's power consumption is optimized while maintaining tracking capabilities. In devices, with inputs components and a graphic user interface (GUI), the input components and GUI will become deactivated, focusing remaining battery charge on extending the longevity of a tracking mechanism-improving the reliability and efficiency of location-based services for UEs.

### SUMMARY

The present disclosure is directed to a tracking mode used to provide a location of a user equipment (UE) with low battery, substantially as shown and/or described in connection with at least one of the Figures, and as set forth more completely in the claims.

According to various aspects of the technology, a tracking mode is used on a mobile UE to provide its location when the UE has a low battery charge. Losing cell phones and other electronic devices has been a problem ever since they were small enough to fit in a pocket. Modern deices typically include software and firmware that permits their locations to be tracked; however, when a battery dies on the device, the last known location is the best guess of its current location. In combination with many users' tendency to use UEs right up until the battery dies, it is not uncommon for the battery of a device to be fully discharged and the device misplaced while in motion. In such an event, the last known position of the UE is not helpful. In other aspects, dedicated tracking devices or ancillary tracking devices (e.g., a child's smart watch) entirely lose their effectiveness if their battery levels are not closely monitored and they accidentally become fully discharged. In order to improve device tracking capabilities, a special reserve power tracking mode is presented herein that modifies a default/normal device functionality to a tracking mode upon a battery charge falling below a predetermined level. In devices with input/output, such as a touch interface or a graphic user interface, the tracking mode prevents all user interaction in order to conserve power-which may lead users to assume the device is powered off. In devices without input/output, such as dedicated trackers, location reporting may change from a normal mode to the tracking mode-including the use of lower-power radios, less fine location services, or less periodic reporting.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects are described in detail below with reference to the attached drawings figures, wherein:

FIG. 1 illustrates a computing device for use with the present disclosure;

FIG. 2 illustrates a network environment in which implementations of the present disclosure may be employed;

FIGS. 3A-3B illustrate a use case of devices with an input/output for use with the present disclosure; and

FIG. 4 depicts a flow diagram of a method in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. A base station suitable for use with the present disclosure includes Wi-Fi access points, fixed wireless access stations, traditional cellular base stations (e.g., macro cells, small cells, and femto cells), satellite radio access network nodes, a mobile hotspot, a connected vehicle, and the like. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Aspects herein may be embodied as, among other things: a method, system, or set of instructions embodied on one or more computer-readable media. Aspects may take the form of a hardware aspect or an aspect combining software and hardware. Some aspects may take the form of a computer program product that includes computer-useable or computer-executable instructions embodied on one or more computer-readable media.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, wearable UEs, such as smart watches, fitness/health trackers, life alert devices, medical devices, and other tracking devices often have small form factors and are susceptible to being misplaced. When misplaced, the limited battery life of many smaller devices means that tracking the device's location is a race against the clock. An inability to locate lost devices can cost users significant amounts of money, increase insurance claims, or result in slower adoption of related technologies. In other situations, wearable UEs or dedicated tracking devices are used by parents/guardians to track children or provide peace of but their purpose is often frustrated by the user forgetting to re-charge the device.

Conventionally, UEs are configured to operate nearly identically, without concern for the UE's battery charge level. In some cases, a graphic user interface may dim to conserve backlighting power consumption, but tracking modalities and input configurations do not change. That is, conventional devices are made to provide the user the same level of use from 100% battery charge until the battery dies.

Unlike conventional solutions, the present disclosure is directed to systems and methods that combine improved power management and an enhanced tracking functionality. As opposed to providing full functionality of a device until battery charge levels reach minimum safe charge levels (i.e., the device powers off, or “dies”), the present disclosure modifies the operations or modalities of the device once its battery charge level reaches a predetermined threshold level. Once the battery charge level reaches or goes below the threshold level, input components, a graphic user interface (GUI), and output components become deactivated—as if the device is dead. In reality, though the device appears powered off, it continues to transmit location messages or beacons that can be used to track the device. In tracking devices without input/output components, message transmission periodicity may change or precise tracking modes may be disabled. By modifying the modalities when a device is in low-power mode, the device will be capable of being tracked for a longer amount of time-especially helpful for misplaced devices or devices associated with minor children or the elderly.

Accordingly, a first aspect of the present disclosure is directed to a system for tracking a user equipment (UE). The system a graphic user interface (GUI). The system further comprises a battery. The system further comprises one or more antenna elements configured to transmit wireless communication signals. The system further comprises a first radio configured to transmit the wireless communication signals using the one or more antenna elements. The system further comprises one or more computer processing components configured to cause the display of one or more user interface elements on the GUI when a battery charge level is above a predetermined threshold. The one or more computer processing components are further configured to not display the one or more user interface elements on the GUI based on a determination that the battery charge level of the battery is below the predetermined threshold. The one or more computer processing components are further configured to transmit a location message while the battery charge level of the battery is below the predetermined threshold.

A second aspect of the present disclosure is directed to a method for tracking a user equipment (UE). The method comprises determining a battery charge level is below a predetermined threshold. The method further comprises modifying the UE modality from a normal mode to a tracking mode based on the previous determination. The method further comprises periodically transmitting a location message while the UE is in the tracking mode.

Another aspect of the present disclosure is directed to a non-transitory computer readable media having instructions stored thereon that, when executed by one or more computer processing components, cause the one or more computer processing components to perform a method for tracking a user equipment (UE). The operations comprise periodically communicating Bluetooth Low Energy (BLE) beacons with a first amount of time between subsequently transmitted beacons while a battery charge level of the UE is above a predetermined threshold. The operations further, based on a determination that the battery charge level of the UE is below the predetermined threshold, periodically communicating the BLE beacons with a second amount of time between subsequently transmitted beacons, the second amount of time being greater than the first amount of time.

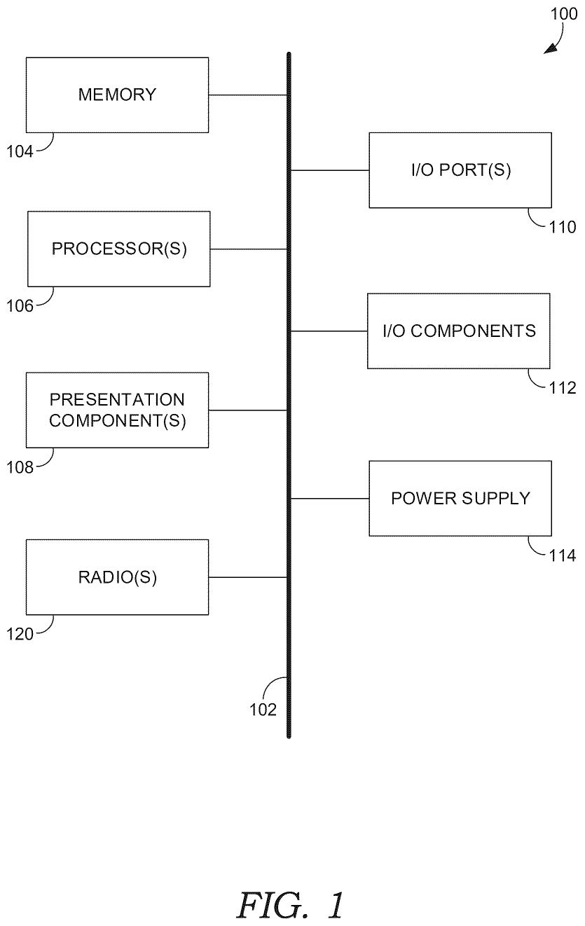

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device, The computing device 100 may take many forms; non-limiting examples of the computing device 100 include a fixed wireless access device, cell phone, tablet, internet of things (IOT) device, smart appliance, automotive or aircraft component, pager, personal electronic device, wearable electronic device, activity tracker, desktop computer, laptop, PC, tracking device, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, touch-enabled graphic user interface, display screen, buttons, switches, watch bevels, motion-activation (e.g., use of an accelerometer or gyrometer), joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Similarly, it is conceived that the computing device 100 may comprise more than two different radios, such as if it comprises a Bluetooth radio, a Wi-Fi radio, a location-finding (e.g., GPS) radio, and at least one cellular radio. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), Bluetooth, Bluetooth Low Energy (BLE), a near field communication (NFC) protocol, WiMAX, LTE, 3G, 4G, LTE, 5G, NR, 6G, VoLTE, or other VOIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

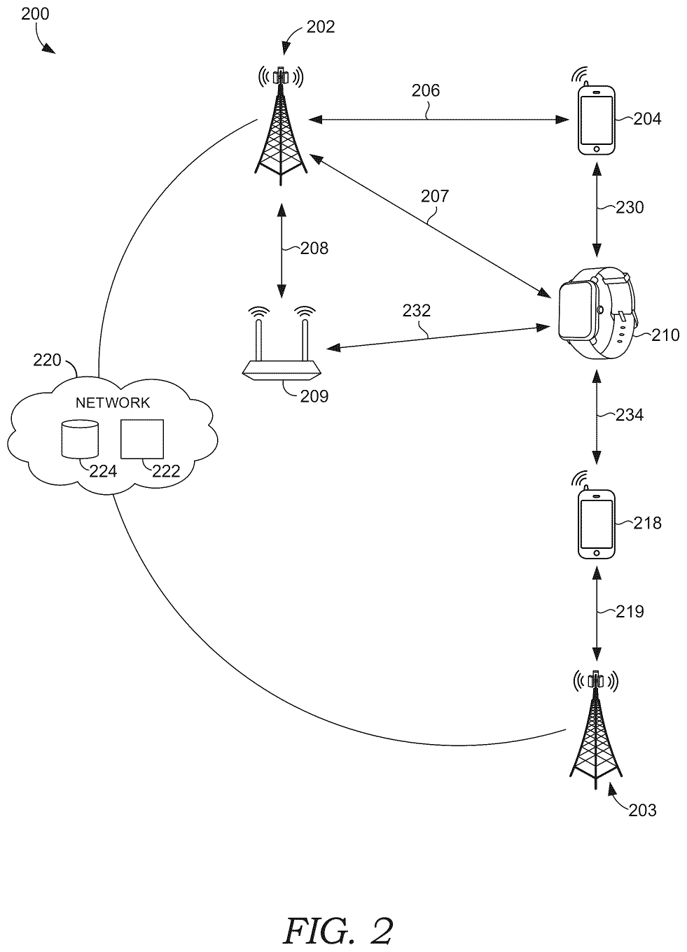

Turning now to FIG. 2, an exemplary network environment is illustrated in which implementations of the present disclosure may be employed. Such a network environment is illustrated and designated generally as network environment 200. At a high level the network environment 200 comprises one or more UEs, including one or more tracked UEs, one or more base stations, and one or more networks.

The network environment 200 comprises one or more base stations with which a UE may wirelessly communicate. Though each of a first base station 202 and a second baes station 203 are illustrated as macro cells on a cell tower, any scale or form of access point acting as a transceiver station for wirelessly communicating with a UE, including small cells, pico cells, and the like, are suitable for use with the present disclosure. Additionally or alternatively, a base station consistent for use with the present disclosure may be an 802.11-based router, such as routers used in typical homes and businesses, a fixed wireless access point, a router, a hotspot, or the like. Each of the first base station 202 and the second base station 203 comprise hardware and software components that allow it to wirelessly communicate with one or more UEs in one or more coverage areas. Though the second base station 203 is included in network environment 200, one skilled in the art will understand that the second base station 203 is not necessary for implementing at least some inventive concepts discussed herein. Each coverage area may be logically defined in space and frequency as one or more cells, which may or may not overlap. The base station 202 is configured to wirelessly communicate with a first UE 204 using a first wireless connection 206. The base station 202 is configured to wirelessly communicate with a second UE 210 using a second wireless connection 208. The base station 202 is configured to wirelessly communicate with a fixed wireless access (FWA) UE 205 using a third wireless connection 207. The present disclosure is agnostic to a particular radio access technology (RAT); accordingly, many different RATs, such as 4G, 5G, 6G, 802.11/Wi-Fi, Bluetooth, NFC, LoRa, and any other protocol suitable for wirelessly transporting data are suitable for use with the present disclosure.

Each base station of the one or more base stations may be associated with one or more at least partially distinct networks, wherein each network is associated with one or more network identifiers. Each network may be a telecommunications network(s) (e.g., a packet data network or core network), data network, or portions thereof. A telecommunications network that at least partially comprises the network environment 200 may include additional devices or components (e.g., one or more base stations) not shown. Those devices or components may form network environments similar to what is shown in FIG. 2, and may also perform methods in accordance with the present disclosure. Components such as terminals, links, and nodes (as well as other components) may provide connectivity in various implementations.

The network environment 200 comprises a network 220. The network 220 includes a cloud-based platform 222 and a database 224. In aspects, the network 200 is a telecommunications network having a plurality of access points that provide service to a plurality of user devices, such as the second UE 210 and the first UE 204. The cloud-based platform 222 and the database 224 operate within the network 220, and as further discussed, can provide services to users via the second UE 210 and the first UE 204. The cloud-based platform 222 may be a virtual server that operates in a cloud computing environment, and which is supported by individual server(s) in data centers. Although a cloud-based platform 222 is discussed herein, it will be understood that platforms which are partially cloud-based or are not cloud-based may be utilized and leveraged, whether alone or in connection with a cloud-based server to perform aspects discussed herein. The database 224 can operate as cloud-based storage that supports the cloud-based platform 222 in a cloud computing environment as shown, or it may instead be partially cloud-based or not cloud-based, in various aspects.

The network environment 200 comprises one or more UEs that are used to track the location of the second UE 210. Accordingly, the network environment 200 at least comprises the first UE 204; the first UE 204 may also be referred to herein as a tracking UE, as its defining characteristic with respect to the present disclosure is to output tracking information associated with the location of the second UE 210. In wherein the second UE 210 is directly connected to the first UE 204 via a first tracking connection 230, or when the second UE 210 is directly connected to the radio access network (RAN), such as via a second wireless connection 207 to the first base station 202, the network environment 200 need not comprise additional UEs. In other aspects, wherein the second UE 210 is neither directly connected to the first UE 204 nor the RAN, then the network environment 200 may comprise additional UEs through which the second UE may communicate. In a first example, the second UE 210 may provide tracking information via a second tracking connection 232 with an access point 209 (e.g., a fixed wireless access point, a Wi-Fi internet router, or a hotspot) that is connected to the first base station 202 (or any other base station) via a third wireless connection 208. In another example, the second UE 210 may provide tracking information via a third tracking connection 234 with a third party UE 218 that is connected to the RAN, such as by a fourth wireless connection 219 to the second base station 203. Though illustrated in one arrangement, when the second UE 210 uses the second tracking connection 232 or the third tracking connection 234, the access point 209 and the third party 218 may be connected to any base station that facilitates communication to the network 220—regardless of whether they do so through the same or a different base station to which the first UE 204 is connected or through the same RAN to which the first base station 202 belongs. Further, though each of the first UE 204 and the third party UE 218 are illustrated as cellular phones, a UE suitable for implementations with the present disclosure may be any computing device having any one or more aspects described with respect to FIG. 1, including, without limitation, a cell phone, a personal computer/laptop, a vehicle or vehicle infotainment display, tablet, and the like

As previously mentioned, the network environment 200 comprises the second UE 210. The second UE 210, which may also be referred to herein as a tracked UE, is characterized by its ability to provide its location information to a destination, such as the first UE 204 or the network 220. Though illustrated as a smart watch, the second UE 210 may take the form of a wearable device such as a fitness tracker, heart rate monitor, step counter, or health alert device. In other aspects, the second UE 210 may take the form of a device that has a primary tracking function, such as a small form personal property tracker (e.g., Apple AirTag, Samsung SmartTag, or Tile Tracker) or a vehicle tracker (e.g., a dedicated GPS tracker or an on-board diagnostic (OBD) device that comprises location services). Accordingly, the second UE 210, having any one or more features of the computing device 100 of FIG. 1, comprises at least one radio and a power supply. In aspects, the second UE 210 may not comprise a location-obtaining module (e.g., GPS); rather, it may utilize low power, limited-range messaging (e.g., specially-encrypted Bluetooth Low Energy (BLE) beacons) to communicate with compatible UEs, such as those that are configured to receive and decrypt said messaging. In other aspects, the second UE 210 may comprise the location-obtaining module and utilize longer-range messaging (e.g., using the second wireless connection 207) to communicate with the network 220. The second UE 210 may have multiple radios that use varying amounts of power to communicate; for example, the second UE 210 may comprise a first (cellular) radio configured to communicate with the first base station 202 using a cellular (e.g., 3G, 4G, 5G, 6G) protocol and one or more limited-range radios (e.g., Bluetooth Low Energy or Wi-Fi) to communicate with devices such as the first UE 204, the access point 209, or the third party UE 218.

The second UE 210 is configured to modify its modality from a normal operating mode to a power-conservation mode, referred to herein for simplicity as “tracking mode” based on a determination that a power supply level is below a predetermined threshold. The predetermined threshold may be user-configurable or managed by a device maker or mobile network operator. In aspects wherein the second UE 210 comprises a GUI, the true battery level may be displayed on the GUI and tracking mode may be entered when the battery (i.e., power supply) level reaches the predetermined threshold; for example, if the predetermined threshold is 10%, then the second UE 210 may function in its normal operating mode until the battery level is 10%, and then the second UE 210 would enter tracking mode. In other aspects, the second UE 210 may account for a reserve charge for use with tracking mode; for example, if the battery of the second UE 210 has a usable capacity (i.e., excluding minimum safety margins) of 300 mAh and the predetermined threshold for the tracking mode is 30 mAh, then the second UE 210 may indicate that it has 10% remaining charge when it has a remaining power level of 57 mAh-which accounts for the fact that 270 mAh of the battery capacity is available for the user and 30 mAh is available as a reserve for tracking mode. In such a reserve capacity aspect, the user may be permitted to use the second UE 210 in a normal mode until the device indicates that the battery level is 0%, at which point the reserve 10% charge will be used to operate the second UE 210 in tracking mode. In yet other aspects, the second UE 210 may have a second and smaller dedicated battery that is only to be used for tracking mode, permitting a user to operate the second UE 210 as normal with the entirety of the second UE 210's main battery capacity.

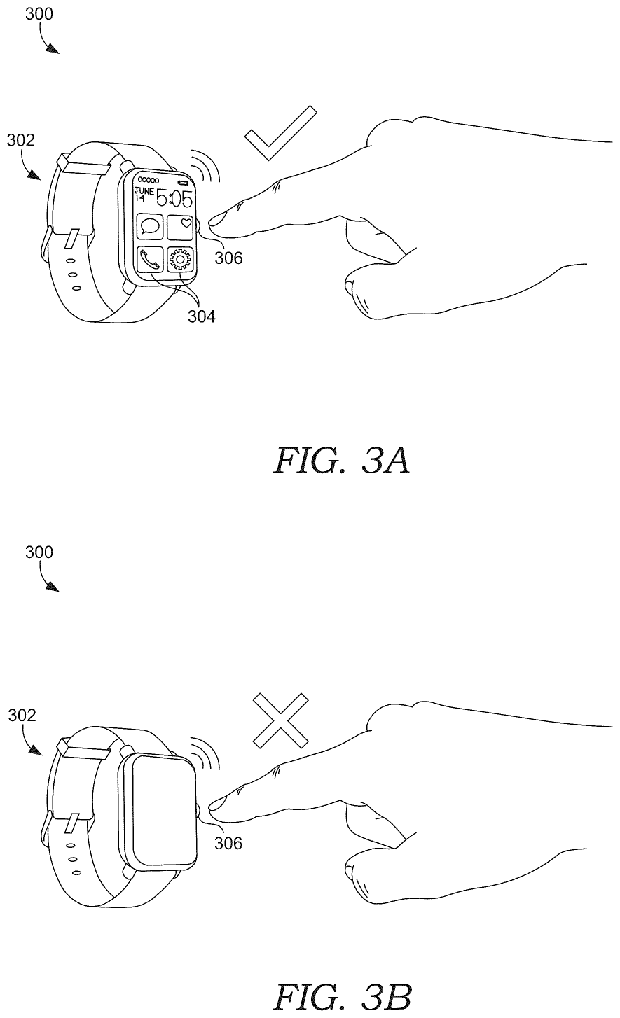

The tracking mode of the present disclosure is generally characterized by reducing functionality or performance from its normal operating mode to the tracking mode. In aspects wherein the second UE 210 has input/output components, such as a smart watch with a touch-enabled graphic user interface and/or one or more physical interface elements (e.g., a rotating bevel, digital crown, buttons, etc.), the tracking mode comprises deactivating the input/output components. In such an aspect, the second UE 210 may appear to be dead (i.e., powered off) to a user even though it continues to provide information that can be used for tracking purposes. Turning now to FIGS. 3A-3B as an illustration of such an embodiment, an environment 300 illustrates the second UE 210 of FIG. 2 as a smart watch 302. When operating normally, as shown in FIG. 3A, the smart watch 302 is configured to display one or more icons, shortcuts, or user interface elements 304 on its touch-enabled graphic user interface, and to receive input via its one or more physical interface elements 306. When in tracking mode, as illustrated in FIG. 3B, the smart watch 302 is configured to be deactivated, showing none of the one or more icons, shortcuts, or user interface elements 304 of FIG. 3A, and is also configured to not receive inputs via the one or more physical interface elements 306. Despite appearing dead/off, the smart watch 302 continues to provide information that can be used to track its location until the power supply is exhausted. Returning to FIG. 2, in aspects where the second UE 210 does not comprise input/output components, tracking mode comprises decreasing tracking functionality using one or more mechanisms in order to conserve power consumption. In a first mechanism, a reporting (i.e., transmission) periodicity is modified; for example, if a first amount of time separated two subsequently transmitted messages in normal mode (i.e., a first periodicity), then a second amount of time (i.e., a second periodicity) may separate two subsequently transmitted messages in tracking mode, wherein the second amount of time is greater than the first amount of time. In a second mechanism, less information may be included in the transmitted messages; for example, if sensor data (e.g., motion, temperature, connection status, sound, etc.) is included in transmitted messages in normal mode, then at least some of the normally-reported sensor data may not be reported in tracking mode. In a third mechanism, a lower-power messaging paradigm may be used; for example, if a cellular connection is used to transmit precise geographic location messages in normal mode, then lower-power-consuming BLE beacons may be transmitted in tracking mode and the cellular radio (and GPS module) may be deactivated. In another aspect of the third mechanism, if an ultra-wideband (UWB) radio transmits messages that can be used for granular tracking while the UE is normal mode, then the UWB may be disabled once the UE enters tracking mode. By disabling the UWB radio, the second UE 210 will be prevented from participating in UWB communications, rendering it unable to respond to UWB queries from nearby devices.

The modified behavior of the second UE 210 while in tracking mode may vary as its battery level decreases in order to provide for increasingly aggressive power saving. In some aspects, the second UE 210 may enter a first tier of tracking mode based on a determination that its battery level is below a first level (e.g., 10% charge remaining) and enter a second tier of tracking mode (also referred to herein as a “critical mode”) based on a later determination that its battery level is below a (lower) second level (e.g., 5% charge remaining). When a tiered tracking mode is implemented, more aggressive modifications to modality of the second UE 210 will occur as it passes subsequently lower power level thresholds. In one non-limiting and illustrative example, the second UE 210 may take the form of a smart watch with multiple radios, a satellite-location module (e.g., GPS), and at least one input/output component (here, a touch-enabled GUI). Based on a determination that the second UE 210's battery level reaches 10% charge remaining, the second UE 210 enters a first tier of tracking mode. In this first tier of tracking mode, the second UE 210 deactivates the touch-enabled GUI, stopping the output of information to the user and preventing the user from inputting commands. While in this first tier of tracking mode, the second UE 210 also continues to obtain/determine a precise geographic location (i.e., latitude/longitude) from the satellite-location module and report the precise geographic location to the first base station 202 via the second wireless connection 207 (in this example, a cellular connection like 5G). If the second UE 210 is not charged and it subsequently determines that its power level decreases to 5% charge remaining, the second UE 210 enters a second tier of tracking mode. In this second tier of tracking mode, the touch-enabled GUI remains deactivated, but the satellite-location module and cellular radio may also be deactivated; instead, a Bluetooth radio may be used to periodically transmit BLE beacons. In aspects where a distinction between a normal mode and a tracking mode is at least in part embodied by increasing transmission/reporting periodicities, the periodicity (i.e., the time interval between occurrences or events) of transmissions may further increase once the second UE 210 passes the second threshold and enters the critical mode. As one skilled in the art would appreciate, many combinations of tiered modalities could be implemented in order to more aggressively conserve the dwindling power supply of the second UE 210 in order to extend the amount of time that location-finding services can be provided.

Regardless of whether the second UE 210 is a wearable device or a tracker, the second UE 210 continues to provide information that can be used for tracking purposes while it is in tracking mode. In some aspects, the second UE 210 may be configured to only provide tracking messages to an associated UE, such as if the second UE 210 was a child's smart watch and the first UE 204 was associated with a parent of said child. For example, if the second UE 210 obtains its precise location and reports it to the network 220, then only the first UE 204 may request (or be pushed) said precise location information. In another example, if the second UE 210 uses BLE beacons for tracking purposes, then only the first UE 204 may be capable of decrypting the beacon, preventing other (unassociated UEs) with information that could be used to determine a proximity to the second UE 210. In other aspects, BLE beacons transmitted by the second UE 210 may be received and decrypted by proximate devices and location information provided to the network 220 by said proximate devices-regardless of whether or not they are previously associated/paired with the second UE 210. In said aspects, the second UE 210 may be configured to periodically transmit an encrypted BLE beacon that may be received by any proximate device capable of decrypting the beacon. All devices having a common attribute (e.g., same mobile network operator (MNO), same operating system, same manufacturer, etc.) may be configured to receive and decrypt the BLE beacon from the second UE 210, and then communicate to the network 220 an indication that the second UE 210 is located in the vicinity of the proximate device. For example, if any device associated with a first MNO is configured to decrypt and process BLE beacons from the second UE 210 and the third party UE 218 is associated with the first MNO, then the third party UE 218 may receive the BLE beacon from the second UE 210 via the third tracking connection 234 and communicate an indication to the network 220 (via the second base station 203) that a BLE beacon was received from the second UE 210 in the vicinity of a location currently associated with the third party UE 218. In another example, if certain equipment (e.g., FWA devices) are configured to decrypt and process BLE beacons from the second UE 210, then the access point 209 may receive the BLE beacon from the second UE 210 via the second tracking connection 232 and communicate an indication to the network 220 (via the first base station 202) that a BLE beacon was received from the second UE 210 in the vicinity of a location currently associated with the access point 209.

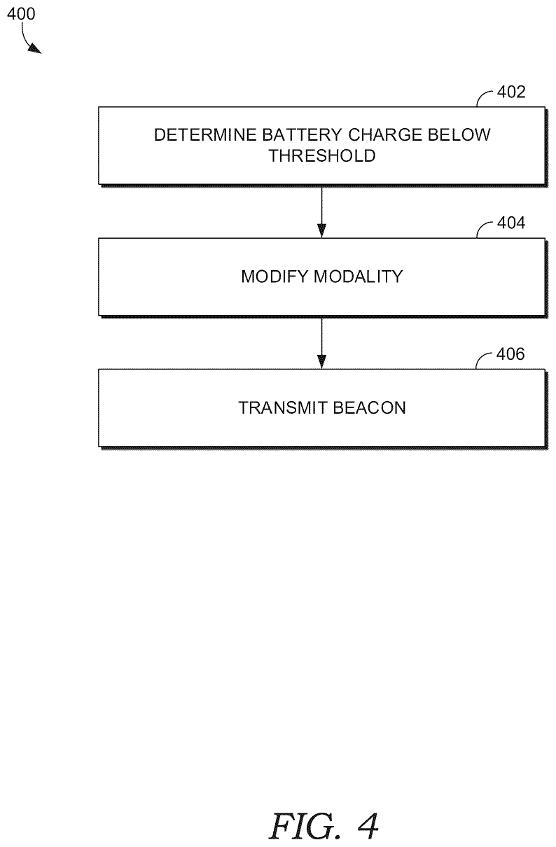

Turning now to FIG. 4, a flow chart representing a method 400 is provided. At a first step 402, it is determined that a battery charge of a user equipment (UE) is below a predetermined threshold, according to any one or more aspects discussed herein. At a second step 404, one or more modalities of the UE are modified; for example, if the UE has one or more input components and a graphic user interface (GUI), then the UE may disable the one or more input components and the GUI based on the determination at step 402. In another example, if the UE reports its location at a first periodicity or using a first mechanism while the battery charge level is above the predetermined threshold, then it may report its location at a second (greater) periodicity or use a second (less power-consuming) mechanism based on the determination at step 402. Any one or more aspects discussed herein with respect to FIGS. 2-3B may additionally or alternatively be used at step 404. At a third step 406, the UE transmits a location message or beacon that may be used for tracking the UE according to any one or more aspects described herein.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for tracking a user equipment (UE), the system comprising:
a graphic user interface (GUI);
a battery;
one or more antenna elements configured to transmit wireless communication signals;
a first radio configured to transmit the wireless communication signals using the one or more antenna elements; and
one or more computer processing components configured to perform operations comprising:
causing display of one or more user interface elements on the GUI when a battery charge level is above a predetermined threshold;
based on a determination that the battery charge level of the battery is below the predetermined threshold, not displaying the one or more user interface elements on the GUI; and
transmitting a location message while the battery charge level of the battery is below the predetermined threshold.

2. The system of claim 1, further comprising at least one physical interface element, and wherein the operations further comprise:
processing a first input from the at least one physical interface element when the battery charge level is above the predetermined threshold; and
based on the determination that the battery charge level of the battery is below the predetermined threshold, not processing a second input from the at least one physical interface element.

3. The system of claim 2, wherein the at least one physical interface element comprises a button.

4. The system of claim 3, wherein the at least one physical interface element additionally comprises a rotating bevel or rotating watch crown.

5. The system of claim 3, wherein the system is a cellular phone.

6. The system of claim 2, wherein the predetermined threshold is configurable by a user via an input to one or more of the GUI and at least one physical interface element.

7. The system of claim 1, wherein the location message is communicated using a cellular protocol and comprises a device identifier and a geographic location.

8. The system of claim 1, wherein the location message is communicated using a Bluetooth Low Energy (BLE) protocol and comprises a device identifier.

9. The system of claim 1, further comprising a second radio, the first radio being a cellular radio and the second radio being a Bluetooth Low Energy (BLE) radio, wherein the first radio periodically transmits a precise location message comprising a geographic location when the battery charge level is above the predetermined threshold, and wherein the second radio periodically transmits the location message while the battery charge level of the battery is below the predetermined threshold.

10. A method for tracking a user equipment (UE), the method comprising:
determining a battery charge level is below a predetermined threshold;
based on said determination, modifying the UE modality from a normal mode to a tracking mode; and
periodically transmitting a location message while the UE is in the tracking mode.

11. The method of claim 10, wherein modifying the UE modality from the normal mode to the tracking mode comprises disabling a graphic user interface of the UE.

12. The method of claim 11, wherein modifying the UE modality from the normal mode to the tracking mode further comprises stopping the processing of one or more inputs from one or more physical interface elements.

13. The method of claim 12, wherein the location message comprises a Bluetooth Low Energy (BLE) beacon.

14. The method of claim 12, wherein modifying the UE modality from the normal mode to the tracking mode further comprises stopping the transmission of precise location messages, the precise location messages being transmitted using a cellular communication protocol.

15. The method of claim 13, wherein the method further comprises modifying the UE modality from the tracking mode to a critical mode based on a second determination that the battery charge level is below a second predetermined threshold, the second predetermined threshold being lower than the first predetermined threshold, and wherein the location message is transmitted at a first periodicity in tracking mode and transmitted at a second periodicity in critical mode, the second periodicity being greater than the first periodicity.

16. The method of claim 10, wherein the location message is transmitted at a first periodicity in the normal mode and transmitted at a second periodicity in the tracking mode, the second periodicity being greater than the first periodicity.

17. The method of claim 16, wherein the method further comprises modifying the UE modality from the tracking mode to a critical mode based on a second determination that the battery charge level is below a second predetermined threshold, the second predetermined threshold being lower than the first predetermined threshold, and wherein the location message is transmitted at a third periodicity in critical mode, the third periodicity being greater than the second periodicity.

18. The method of claim 16, wherein the method further comprises disabling an ultra-wideband radio based on the determination that the battery level of the UE is below the predetermined threshold.

19. A non-transitory computer readable media having instructions stored thereon that, when executed by one or more computer processing components, cause the one or more computer processing components to perform a method for tracking a user equipment (UE), the operations comprising:
periodically communicating Bluetooth Low Energy (BLE) beacons with a first amount of time between subsequently transmitted beacons while a battery charge level of the UE is above a predetermined threshold; and
based on a determination that the battery charge level of the UE is below the predetermined threshold, periodically communicating the BLE beacons with a second amount of time between subsequently transmitted beacons, the second amount of time being greater than the first amount of time.

20. The non-transitory computer readable media of claim 19, wherein the operations further comprise disabling an ultra-wideband radio based on the determination that the battery level of the UE is below the predetermined threshold.
